(19) United States
(12) Patent Application Publication
(10) Pub. No.: US 2016/0198028 A1
(43) Pub. Date: Jul. 7, 2016

(54) ANTENNA DEVICE AND ELECTRONIC APPARATUS

(71) Applicant: Dexerials Corporation, Tokyo (JP)

(72) Inventor: Katsuhisa ORIHARA, Utsunomiya-shi, Tochigi (JP)

(73) Assignee: Dexerials Corporation, Shinagawa-ku, Tokyo (JP)

(21) Appl. No.: 14/915,688

(22) PCT Filed: Sep. 3, 2014
(86) PCT No.: PCT/JP2014/004528

§ 371 Date: Mar. 1, 2016

(30) Foreign Application Priority Data
Sep. 9, 2013 (JP) 2013-186322

(51) Int. Cl. H04M 1/02

(52) U.S. Cl. CPC H04M 1/026

(57) ABSTRACT

The balance between communicable regions in the x-direction and the y-direction with respect to an antenna on the side of a reader/writer that is facing in the xy-plane is improved, allowing reliable communication via an electromagnetic field signal transmitted from the reader/writer. An antenna device incorporated into an electronic apparatus and configured to communicate with an external device via an electromagnetic field signal includes an antenna coil (11A) having formed therein a loop antenna (21A) disposed on a peripheral portion of a casing surface of the electronic apparatus and having an external shape formed by bending a long side of a rectangular shape into which a coil that inductively couples to the external device is wound, thereby improving the balance between communicable regions in the x-direction and the y-direction with respect to an antenna (121) on the side of a reader/writer that is facing in the xy-plane.

### CROSS-REFERENCE TO RELATED APPLICATION

This application claims priority to and the benefit of Japanese Patent Application No. 2013-186322 filed Sep. 9, 2013, the entire contents of which are incorporated herein by reference.

### TECHNICAL FIELD

This disclosure relates to an antenna device incorporated into an electronic apparatus and capable of communicating via an electromagnetic field signal transmitted by a transmitter and also relates to an electronic apparatus.

### BACKGROUND

Electronic apparatuses, such as cellular phones, smartphones, and tablet PCs, have traditionally employed an antenna module for RFID (Radio Frequency Identification) to provide the function of short-distance contactless communication.

This antenna module communicates by making use of inductive coupling to an antenna coil incorporated into a transmitter, such as a reader/writer. In other words, this antenna device can drive an IC that converts a magnetic field which an antenna coil receives from a reader/writer into electric power, thereby functioning as a communication processor.

For reliable communication, the antenna module needs to receive at least a certain value of magnetic flux from the reader/writer via the antenna coil. Therefore, an antenna device according to a known example is provided with a loop coil in the casing of a cellular phone and receives magnetic flux from the reader/writer via this coil.

In the antenna module incorporated into an electronic apparatus such as a cellular phone, metal such as a substrate in the apparatus, a battery pack, or the like receives the magnetic field from the reader/writer, thereby generating eddy current that repels the magnetic flux from the reader/writer. For example, considering the casing surface of a cellular phone, the magnetic field coming from the reader/writer tends to strengthen at the peripheral portion of the casing surface and weaken near the center of the casing surface.

In the case of an antenna using a regular loop coil, the opening of the loop coil is positioned in the central portion of the cellular phone, where there is little reception of the above-described magnetic field that passes through the peripheral portion of the casing surface. Therefore, with an antenna using a regular loop coil, the efficiency of receiving a magnetic field is poor.

Therefore, an antenna device in which the loop antenna is disposed in the peripheral portion of the casing surface, where the magnetic field from the reader/writer is strong, and an antenna device that uses a magnetic sheet to increase magnetic flux and enhance performance have been proposed. In these antenna devices, the loop antenna is shaped to be rectangular, with the long sides disposed along the outer peripheral edge of the casing surface (for example, see JP 4883125 B2 (PTL 1), JP 4894945 B2 (PTL 2), JP 5135450 B2 (PTL 3), and JP 2012-217133 A (PTL 4)).

### CITATION LIST

Patent Literature

PTL 1: JP 4883125 B2

PTL 2: JP 4894945 B2

PTL 3: JP 5135450 B2

PTL 4: JP 2012-217133 A

### SUMMARY

### Technical Problem

In an antenna device in which the loop antenna is disposed in the peripheral portion of the casing surface to enhance performance, however, the loop antenna is shaped to be rectangular, with the long sides disposed along the outer peripheral edge of the casing surface. Therefore, since the antenna coil that receives magnetic flux from the reader/writer is rectangular, the operating area with respect to a compact antenna becomes a rectangular region that is short in a direction orthogonal to the long side of the antenna coil, causing the problem of a narrow communicable region. In other words, as illustrated in FIG. 11, in the xy-plane, there is a difference between the communicable region in the x-direction corresponding to the longitudinal direction of the antennal coil and the communicable region in the y-direction corresponding to the direction orthogonal to the long side of the antenna coil. The communicable region in the y-direction is narrower.

Therefore, as an antenna device that enhances performance by disposing a loop antenna in the peripheral portion of the casing surface, it would be helpful to provide an antenna device that can expand the communicable region in the direction orthogonal to the long side of the antennal coil and can reliably communicate via an electromagnetic field signal transmitted by a transmitter.

Other aspects of this disclosure and the specific advantages obtained with this disclosure will become clearer from the explanation of the embodiments described below.

### Solution to Problem

In this disclosure, the communicable region in the y-direction orthogonal to the long side of an antenna coil is expanded by bending a long side of a rectangular loop antenna in an antenna device that enhances performance by disposing a loop antenna in the peripheral portion of the casing surface.

In other words, an antenna device according to this disclosure is incorporated into an electronic apparatus and configured to communicate with an external device via an electromagnetic field signal, and the antenna device includes a loop antenna disposed on a peripheral portion of a casing surface of the electronic apparatus and having an external shape formed by bending a long side of a rectangular shape into which an antenna coil that inductively couples to the external device is wound.

In the antenna device of this disclosure, the external shape of the loop antenna may be formed by bending the long side of the rectangular shape sharply.

In the antenna device of this disclosure, the external shape of the loop antenna may be formed by bending the long side of the rectangular shape at a plurality of positions.

In the antenna device of this disclosure, the external shape of the loop antenna may be formed by bending the long side of the rectangular shape along an outer peripheral edge of the casing surface.

The antenna device of this disclosure may further include a first electric conductor provided inside a casing of the electronic apparatus and facing the external device; and a second electric conductor in sheet form, provided inside the casing of the electronic apparatus, proximate to or in contact with the first electric conductor, and at least partially overlapping a surface of the antenna coil, the surface being opposite to a surface of the antenna coil facing the external device.

The antenna device of this disclosure may further include a magnetic sheet configured to pull in a magnetic field transmitted from the external device in the antenna coil, such that the antenna coil and the magnetic sheet overlap each other by the magnetic sheet being inserted into a center portion of the antenna coil so as to satisfy a disposition condition such that, towards a center of a casing surface facing the external device, the magnetic sheet is positioned closer to the external device than the antenna coil is, and to satisfy another disposition condition such that, towards an outer periphery of the casing surface, the antenna coil is positioned closer to the external device than the magnetic sheet is.

An electronic apparatus according to this disclosure incorporates an antenna device configured to communicate with an external device via an electromagnetic field signal, and the antenna device includes: a loop antenna disposed on a peripheral portion of a casing surface of the electronic apparatus and having an external shape formed by bending a long side of a rectangular shape into which an antenna coil that inductively couples to the external device is wound; a first electric conductor facing the external device; a second electric conductor in sheet form, overlapping or in contact with the first electric conductor, and at least partially overlapping a surface of the antenna coil, the surface being opposite to a surface of the antenna coil facing the external device; and a communication processor configured to communicate with the external device.

### Advantageous Effect

In this disclosure, a long side of a rectangular loop antenna is bent in an antenna device that enhances performance by disposing a loop antenna in the peripheral portion of the casing surface, thereby providing an antenna device that can expand the communicable region in the direction orthogonal to the long side of the antenna coil and can reliably communicate via an electromagnetic field signal transmitted from a transmitter.

### BRIEF DESCRIPTION OF THE DRAWINGS

In the accompanying drawings:

FIG. 1 is a perspective view schematically illustrating the structure of a wireless communication system to which this disclosure is applied;

FIG. 2 is a perspective view illustrating an antenna coil and a metal plate in the wireless communication system;

FIG. 3 is a perspective view illustrating an example of the interior of an electronic apparatus in the wireless communication system, illustrating the case of using a metal cover attached to the inside of the casing as the first electric conductor;

FIG. 4 is a perspective view illustrating an example of the interior of an electronic apparatus in the wireless communication system, illustrating the case of using the metal housing of a battery pack as the first electric conductor;

FIG. 5 is a perspective view illustrating an example of the interior of an electronic apparatus in the wireless communication system, illustrating the case of using a metal plate provided on the back side of a liquid crystal module as the first electric conductor;

FIG. 6A is a perspective view and FIG. 6B is a side view, both illustrating an antenna device incorporated into an electronic apparatus;

FIG. 7 is a perspective view illustrating a state in which metal foil overlaps one side of an antenna substrate over the full width in the longitudinal direction of the antenna substrate;

FIG. 8A is a perspective view and FIG. 8B is a cross-sectional side view, both illustrating the structure of an antenna module in which a magnetic sheet is inserted into the antenna substrate;

FIGS. 9A and 9B are plan views illustrating configuration examples of an antenna coil in an antenna device to which this disclosure is applied, with FIG. 9A illustrating a configuration example of an antenna coil in which is formed a loop antenna having an external shape formed by bending, at a right angle, a long side of a rectangular shape into which an antenna coil is wound, and FIG. 9B illustrating a configuration example of an antenna coil in which is formed a loop antenna having an external shape formed by bending, at two locations, the long sides of a rectangular shape into which an antenna coil is wound;

FIG. 10A is a perspective view and FIG. 10B is a plan view, each schematically illustrating a configuration example of the main section of an antenna device to which this disclosure is applied;

FIG. 11A is a perspective view and FIG. 11B is a plan view, each schematically illustrating a configuration example of the main section of an antenna device provided with a loop antenna having a basic structure in which a lead wire of an antenna coil is wound in a rectangular shape;

FIG. 12 is a perspective view schematically illustrating a placement example of an antenna device to which this disclosure is applied;

FIG. 13 is a perspective view schematically illustrating another placement example of an antenna device to which this disclosure is applied;

FIG. 14 illustrates the results of a simulation for an antenna device to which this disclosure is applied and an antenna device according to a Comparative Example, the simulation showing the coupling coefficient when the antenna on the side of the reader/writer that faces the antenna device in the xy-plane is displaced in the x-direction; and

FIG. 15 illustrates the results of a simulation for an antenna device to which this disclosure is applied and an antenna device according to a Comparative Example, the simulation showing the coupling coefficient when the antenna on the side of the reader/writer that faces the antenna device in the xy-plane is displaced in the y-direction.

### DETAILED DESCRIPTION

Embodiments of this disclosure are described below in detail with reference to the drawings. It should be noted that this disclosure is not limited only to the following embodiments, and various modifications may of course be made without deviating from the scope of this disclosure. Moreover, the drawings are schematic, and the ratios of dimensions in the drawings may differ from the actual ratios. Specific dimensions and the like should be determined in light of the following description. Furthermore, the relationship between dimensions and the ratio thereof may of course differ between drawings.

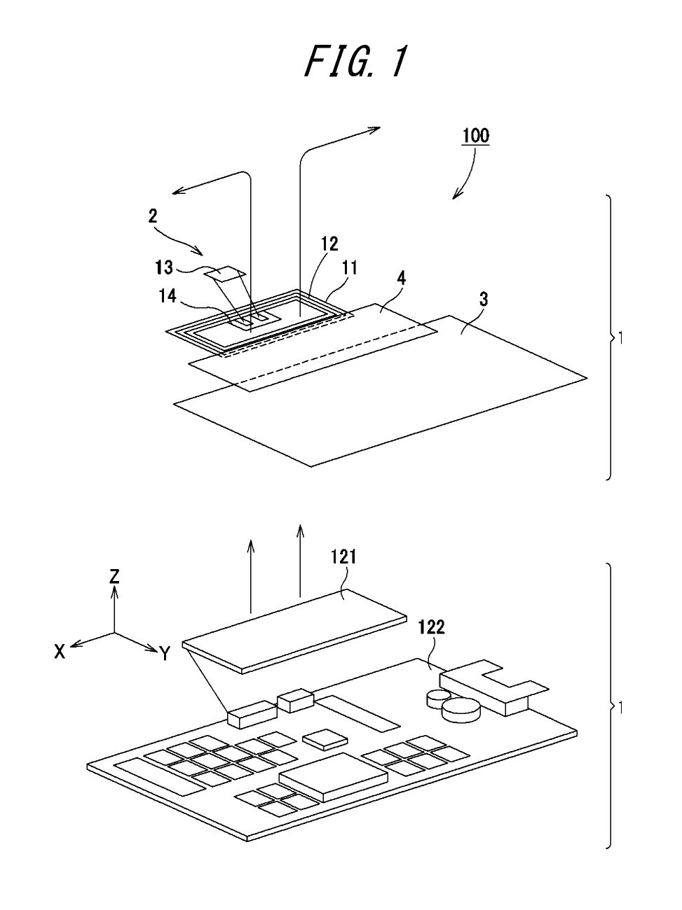

An antenna device according to this disclosure is a device incorporated into an electronic apparatus and configured to communicate with an external device via an electromagnetic field signal. The antenna device is, for example, used by being incorporated into a wireless communication system 100 for Radio Frequency Identification (RFID) as illustrated in FIG. 1.

The wireless communication system 100 includes an antenna device 1 and a reader/writer 120 configured to access the antenna device 1. Here, the antenna device 1 and the reader/writer 120 are arranged so as to face each other in the xy-plane of a three-dimensional orthogonal xyz coordinate system.

The reader/writer 120 functions as a transmitter configured to transmit a magnetic field in the z-axis direction to the antenna device 1 facing the reader/writer 120 in the xy-plane. Specifically, the reader/writer 120 includes an antenna 121 configured to transmit a magnetic field to the antenna device 1 and a control substrate 122 configured to communicate with the antenna device 1 inductively coupled to the reader/writer 120 via the antenna 121.

In other words, the reader/writer 120 is provided with the control substrate 122 that is electrically connected to the antenna 121. On this control substrate 122, a control circuit including one or a plurality of electronic parts, such as integrated circuit chips, is mounted. The control circuit performs various kinds of processing based on data received from the antenna device 1. For example, when transmitting data to the antenna device 1, the control circuit encodes the data, modulates a carrier wave of a predetermined frequency (for example, 13.56 MHz) based on the encoded data, amplifies the modulated modulation signal, and drives the antenna 121 with the amplified modulation signal. Furthermore, when reading data out from the antenna device 1, the control circuit amplifies a modulation signal of data received by the antenna 121, demodulates the amplified data modulation signal, and decodes the demodulated data. The control circuit uses an encoding scheme and modulation scheme that are employed in common reader/writers, such as Manchester encoding and Amplitude Shift Keying (ASK) modulation.

Hereinafter, an antenna device and the like in the contactless communication system 100 are described, but the antenna device and the like may of course be applied similarly to a contactless charging system, such as Qi.

The antenna device 1 is incorporated inside a casing of an electronic apparatus, such as a cellular phone, which is arranged so as to face the reader/writer 120 in the xy-plane at the time of communication. The antenna device 1 includes an antenna module 2 incorporated inside the casing of the electronic apparatus and configured to communicate with the inductively coupled reader/writer 120; a metal plate 3 as a first electric conductor, provided inside the casing of the electronic apparatus, and facing the reader/writer 120; and a metal foil 4 as a second electric conductor in sheet form, provided inside the casing of the electronic apparatus, overlapping or in contact with the metal plate 3, and at least partially overlapping a surface of a coil 12 of the antenna module 2, the surface being opposite to a surface facing the reader/writer 120.

The antenna module 2 includes an antenna coil 11 capable of communicating with the inductively coupled reader/writer 120, and a communication processor 13 configured to be driven by a current flowing through the antenna coil 11 and to communicate with the reader/writer 120.

On the antenna coil 11, the coil 12 and a terminal 14 are mounted. The coil 12 is formed by patterning a flexible lead wire, such as a flexible flat cable, and the terminal 14 electrically connects the coil 12 to the communication processor 13.

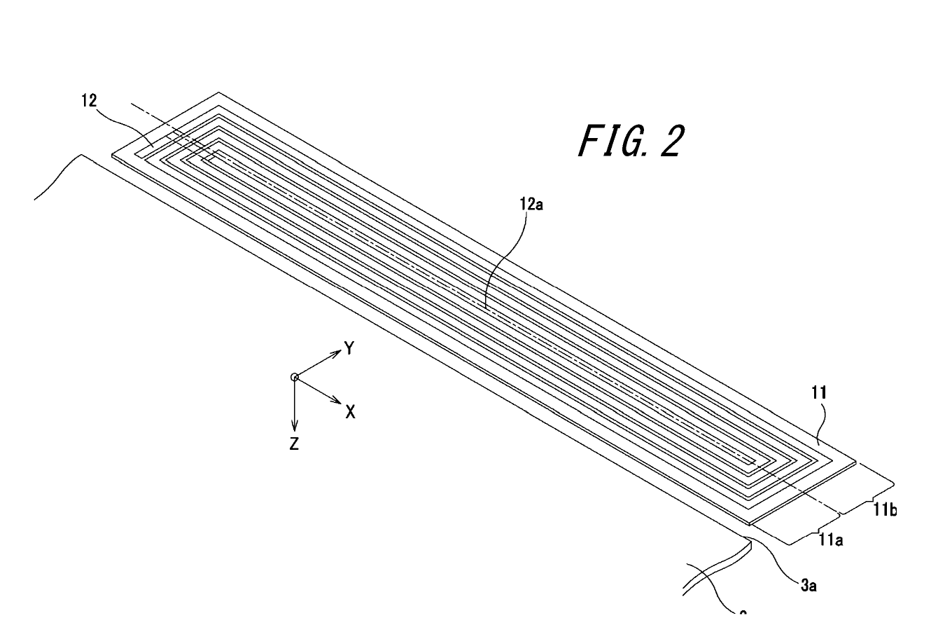

Here, the antenna device 1 is described as having a basic structure in which the antenna coil 11 has an approximately rectangular shape as illustrated in FIG. 2, and one lead wire of the coil 12 is wound around along the external shape of the antenna coil 11.

The antenna coil 11 is disposed so that a principal surface of the wound coil 12 faces the reader/writer 120 in the xy-plane at the time of communication. The antenna coil 11 is divided at the center 12a of the coil 12 into one side 11a, on which the lead wire of the coil 12 is wound so that current flowing along the longitudinal direction of the antenna coil flows in one direction, and another side 11b, on which the lead wire of the coil 12 is wound so that the current flowing along the longitudinal direction flows in the opposite direction. Furthermore, the antenna coil 11 is disposed so that one side edge along the longitudinal direction of the antenna coil faces the metal plate 3, i.e. so that the one side 11a or the other side 11b faces the metal plate 3.

When receiving a magnetic field transmitted from the reader/writer 120, the antenna coil 11 is magnetically coupled to the reader/writer 120 by inductive coupling, thereby receiving a modulated electromagnetic wave and sending the received signal to the communication processor 13 via the terminal.

The communication processor 13 is driven by current flowing through the antenna coil 11 and communicates with the reader/writer 120. Specifically, the communication processor 13 demodulates a received modulation signal, decodes the demodulated data, and writes the decoded data to an internal memory of the communication processor 13. Furthermore, the communication processor 13 reads out data, which are to be transmitted to the reader/writer 120, from the internal memory; encodes the read-out data; modulates a carrier wave based on the encoded data; and transmits the modulated wave to the reader/writer 120 via the antenna coil 11 magnetically coupled to the reader/writer 120 by inductive coupling.

Instead of being driven by electric power flowing through the antenna coil 11, the communication processor 13 may be driven by electric power supplied from electric power supply means, such as a battery pack incorporated into the electronic apparatus, an external power source, or the like.

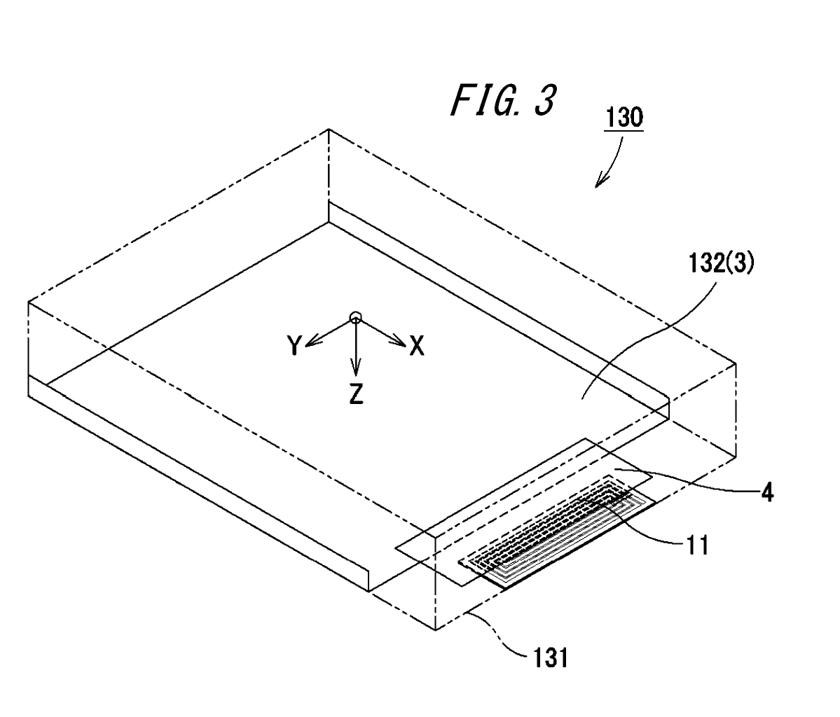

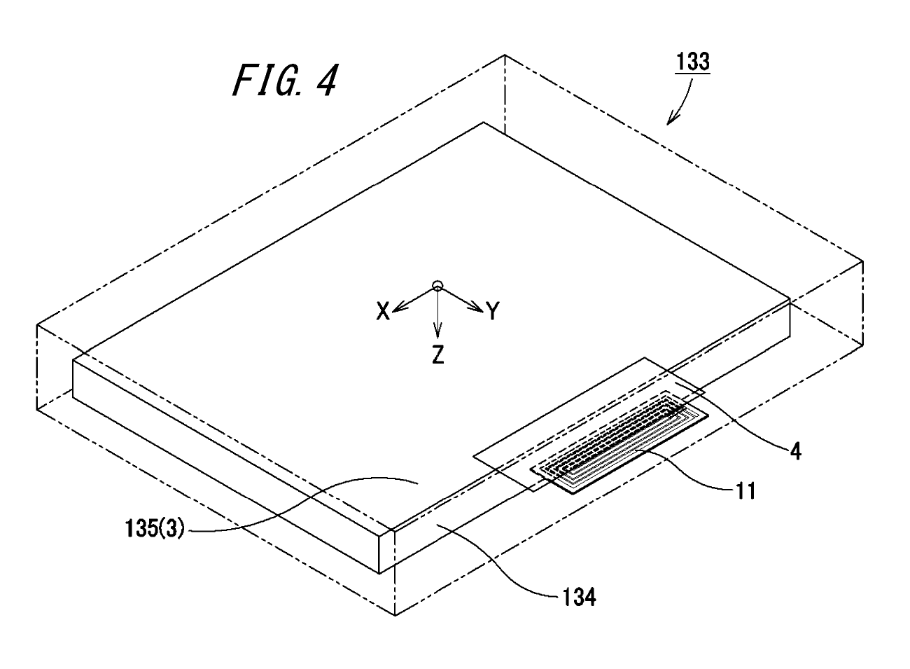

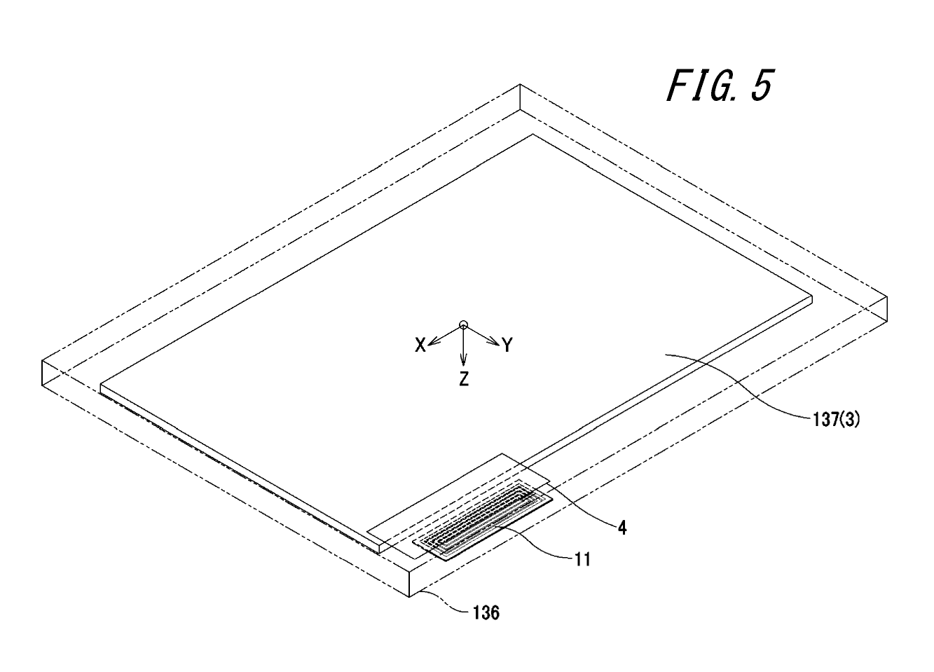

The metal plate 3 constitutes a first electric conductor which is provided inside the casing of an electronic apparatus, such as a cellular phone, a smartphone, or a tablet PC, and faces the reader/writer 120 at the time of communication through the antenna module 2. The first electric conductor corresponds to, for example, a metal cover 132 attached to the inner surface of a casing 131 of a smartphone 130 illustrated in FIG. 3, a metal housing 135 of a battery pack 134 housed in a smartphone 133 illustrated in FIG. 4, or a metal plate 137 provided on the back side of a liquid crystal module of a tablet PC 136 illustrated in FIG. 5. Hereinafter, mainly taking the smartphone 133 as an example of an electronic apparatus, the following describes how, in the metal housing 135 of the battery pack 134 housed in the smartphone 133, the principal surface facing the reader/writer 120 at the time of communication serves as the metal plate 3 constituting the first electric conductor.

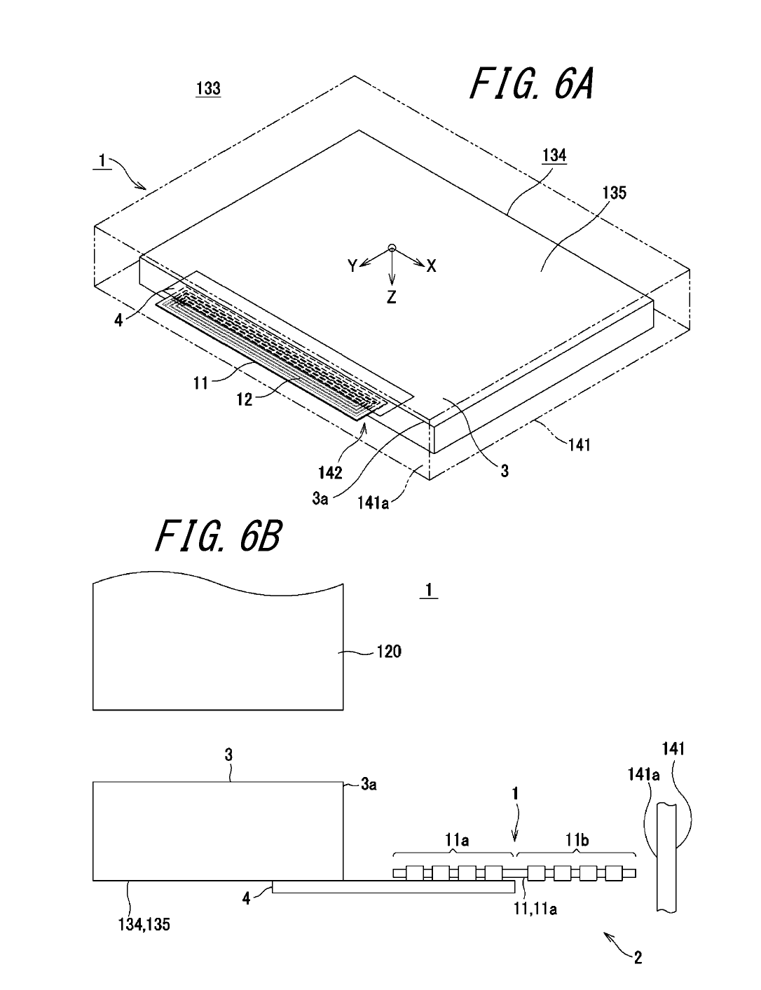

In order to reduce the smartphone 133 in size while achieving good communication characteristics with the reader/writer 120 when the antenna coil 11 of the antenna module 2 is incorporated into the smartphone 133, the antenna coil 11 is disposed, in the xy-plane of a three-dimensional orthogonal xyz coordinate system as illustrated in FIG. 6A, for example in a space 142 between the battery pack 134 provided inside an outer casing 141 of the smartphone 133 and an inner circumference wall 141a of the outer casing 141. Specifically, the antenna coil 11 is disposed between the inner circumference wall 141a of the outer casing 141 and an end portion 3a of the metal plate 3 of the metal housing 135 of the battery pack 134 as illustrated in FIG. 6B, the metal plate 3 facing the reader/writer 120.

Here, the metal plate 3 constituting the metal housing of the battery pack 134 disposed in the smartphone 133 as illustrated in the cross-sectional view of FIG. 6B allows electricity to flow therethrough comparatively easily. Therefore, an eddy current is generated when an AC magnetic field is applied from the outside, thereby repelling the magnetic field. Examining the magnetic field distribution obtained by such addition of an AC magnetic field from the outside reveals that the end portion 3a of the metal plate 3 of the battery pack 134, the metal plate 3 facing the reader/writer 120, characteristically has a stronger magnetic field.

To achieve good communication characteristics by taking advantage of such strength characteristics of the magnetic field inside the casing 131 of the smartphone 130, for example the center 12a parallel to the x-axis is disposed to pass through the space 142 between the end portion 3a of the metal plate 3 and the inner circumference wall 141a of the outer casing 141, as illustrated in FIG. 2, and one side edge in the longitudinal direction is oriented toward the end portion 3a of the metal plate 3, i.e. the one side 11a is oriented toward the end portion 3a of the metal plate 3.

At this time, the antenna coil 11 may be disposed at a position separated from the end portion 3a of the metal plate 3, so as not to touch the end portion 3a. Thus, even in the case where the metal plate 3 and the antenna coil 11 are disposed in such a way as to be separated from each other due to the constraints of the layout of the casing of the electronic apparatus, the overlapping of metal foil 4 with the metal plate 3 and with the antenna coil 11 allows the antenna device 1 to achieve good communication characteristics.

The antenna coil 11 may, however, be in contact with the metal plate 3. Furthermore, the antenna coil 11 may overlap the metal plate 3. At this time, it is beneficial to arrange the antenna coil 11 so that the one side 11a overlapped with the below-described metal foil 4 overlaps the metal plate 3, whereas the other side 11b does not overlap the metal plate 3. If the other side 11b and the metal plate 3 overlap each other, there is a risk of inhibiting the inductive coupling between the other side 11b and magnetic flux of the reader/writer 120.

Between the antenna coil 11 and the metal plate 3, the metal foil 4 is provided to serve as the second electric conductor in sheet form, the metal foil 4 overlapping or being in contact with the metal plate 3 (first electric conductor) and at least partially overlapping a surface of the antenna coil 11, the surface being opposite to a surface facing the reader/writer 120. The overlapping of the metal foil 4 with a part of the antenna coil 11 causes a magnetic field to be repelled in the overlapped part of the antenna coil 11, thereby controlling the inductive coupling in the overlapping area, promoting the concentration of magnetic flux onto the non-overlapping area, and improving communication performance.

In other words, magnetic flux that comes from the reader/writer and passes through the antenna coil 11 causes current to flow in opposite directions between one side 11a on which the lead wire of the coil is wound in one direction and the other side 11b on which the lead wire of the coil is wound in another direction, and, as a result, efficient coupling is prevented.

Hence, in the antenna device 1, the metal foil 4 is made to partially overlap a surface of the antenna coil 11, the surface being opposite to a surface facing the reader/writer 120, thereby repelling a magnetic field in the overlapping area, controlling inductive coupling in the overlapping area, and efficiently transmitting current generated in the non-overlapping area. Furthermore, in the antenna device 1, the metal foil 4 is made to partially overlap a surface of the antenna coil 11, the surface being opposite to a surface facing the reader/writer 120, thereby concentrating magnetic flux onto the non-overlapping area and promoting efficient power generation in this area.

In the antenna device 1, the metal foil 4 also overlaps or is in contact with the metal plate 3, and accordingly, without leakage of magnetic flux from the metal plate 3, the magnetic flux can be induced to the area of the antenna coil 11 not overlapped by the metal foil 4, allowing inductive coupling to be performed efficiently. By the metal foil 4 also overlapping the metal plate 3 in the antenna device 1, current generation caused by inductive coupling, in a part overlapped by the metal foil 4, due to leakage flux from the metal plate 3 can be prevented.

As the metal foil 4, a good conductor, such as copper foil, is preferably employed, but use of a good conductor is not necessary. The thickness of the metal foil 4 may be suitably determined according to the communication frequency between the antenna device 1 and the reader/writer 120. For example, at a communication frequency of 13.56 MHz, a metal foil having a thickness of 20 μm to 30 μm may be used.

As long as the metal foil 4 overlaps the metal plate 3 or the antenna coil 11, the metal foil 4 does not necessarily need to be in a state of contact. Placing the metal foil 4 closer to the metal plate 3 and the antenna coil 11, however, is more advantageous for the coupling coefficient, and therefore the metal foil 4 is preferably adjacent to or in contact with the metal plate 3 or the antenna coil 11.

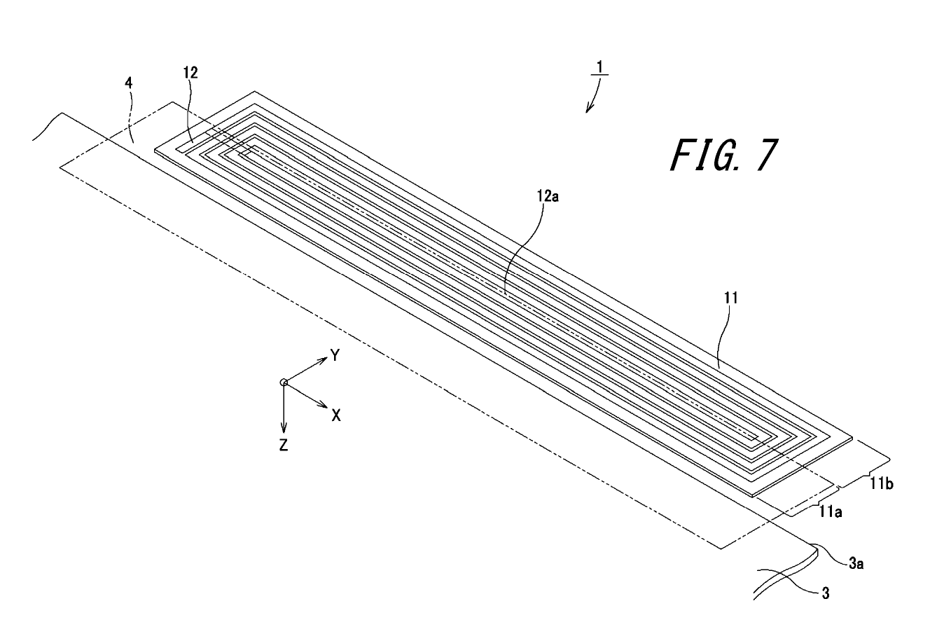

As illustrated in FIG. 7, the metal foil 4 preferably overlaps from an end portion of the one side 11a of the antenna coil 11 to the center 12a of the coil 12. Thus, the metal foil 4 can control the coupling in the one side 11a of the antenna coil 11, thereby making a relative reduction in the amount of current flowing in a direction opposite to current generated in the other side 11b, and the metal foil 4 can induce magnetic flux from the one side 11a of the antenna coil 11 to the other side 11b thereof, thereby promoting the coupling in the other side 11b and improving communication characteristics.

As illustrated in FIG. 7, the metal foil 4 preferably has a width of at least the width in the longitudinal direction of the one side 11a of the antenna coil 11 and overlaps the one side 11a of the antenna coil 11 completely over the longitudinal direction. In this way as well, the metal foil 4 can control the inductive coupling in the one side 11a of the antenna coil 11, thereby making a relative reduction in the amount of current flowing in a direction opposite to current generated in the other side 11b, and the metal foil 4 can induce magnetic flux from the one side 11a of the antenna coil 11 to the other side 11b thereof, thereby promoting the coupling in the other side 11b and improving communication characteristics.

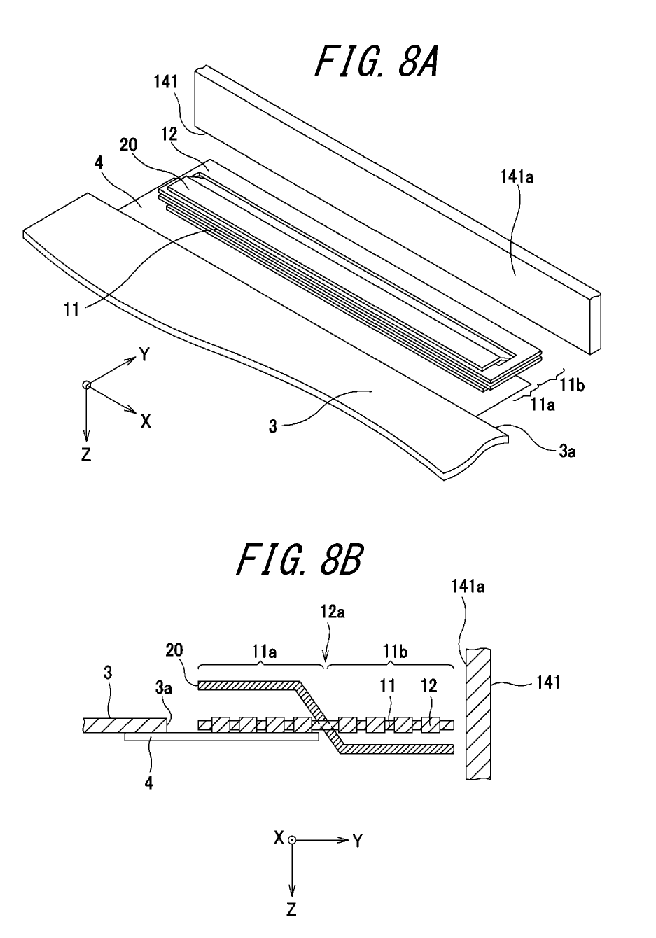

As illustrated for example in FIG. 8A and FIG. 8B, the antenna module 2 may be formed by inserting the magnetic sheet 20 into the antenna coil 11. As illustrated in FIG. 8B, in the antenna coil 11 illustrated in FIG. 8A, the magnetic sheet 20 is inserted into an opening formed in the center 12a of the coil 12 in such a way that, on the one side 11a, the magnetic sheet 20 is positioned closer to the reader/writer 120 than the coil 12 is, whereas on the other side 11b, the coil 12 is positioned closer to the reader/writer 120 than the magnetic sheet 20 is.

In other words, in this antenna coil 11, the opening is formed in the center 12a of the coil 12 across the longitudinal direction thereof, and the magnetic sheet 20 is inserted into this opening. Hence, the coil 12 and the magnetic sheet 20 overlap each other by the magnetic sheet 20 being inserted into the center portion 12a of the coil 12 formed on a printed circuit board so as to satisfy a disposition condition such that, towards the center of the casing surface facing the reader/writer 120, the magnetic sheet 20 is positioned closer to the reader/writer 120 than the coil 12 is, and to satisfy another disposition condition such that, towards the outer periphery of the casing surface, the coil 12 is positioned closer to the reader/writer 120 than the magnetic sheet 20 is.

The antenna coil 11 thus structured so that the magnetic sheet 20 is inserted into the central portion 12a of the coil 12 can reliably pull in a magnetic field transmitted from the reader/writer 120 in the coil 12. In other words, the magnetic field concentrated at the end portion 4a of the metal foil 4 can more efficiently be induced to the magnetic sheet 20. The induced magnetic field causes a large electromotive force in the coil 12, thereby allowing further improvement in communication characteristics.

In the above explanation, the antenna device 1 provided in the wireless communication system 100 is described as having a basic structure in which the antenna coil 11 in the antenna device 1 has an approximately rectangular shape, and the lead wire of the coil 12 is wound around along the external shape of the antenna coil 11, as illustrated in FIG. 2. The antenna device 1 to which this disclosure is applied, however, uses a loop antenna having an external shape formed by bending a long side of a rectangular shape into which the coil 12 that inductively couples to the external device, i.e. to the reader/writer 120, is wound.

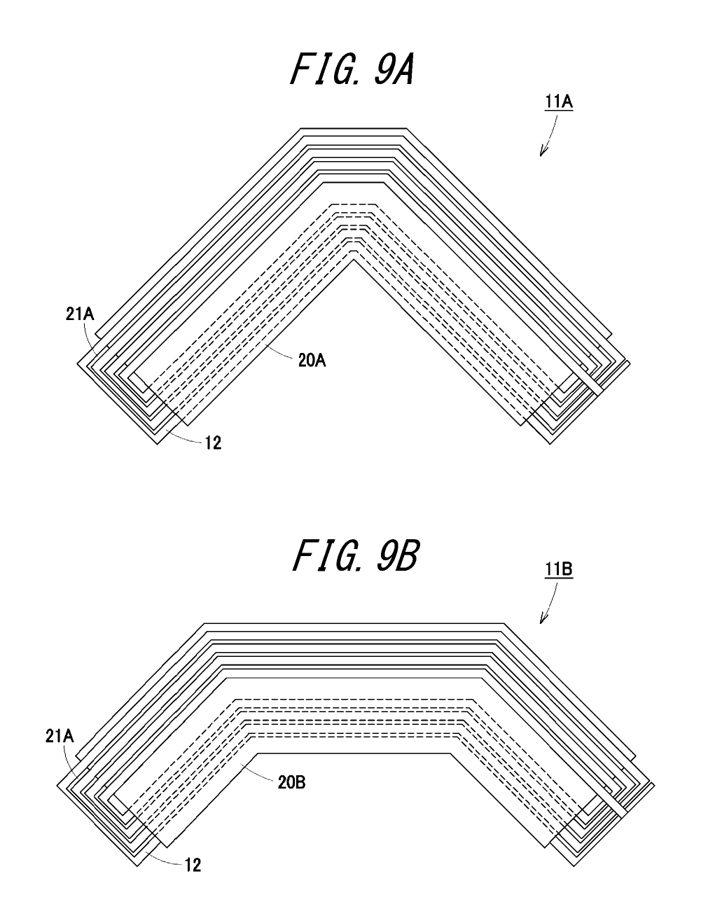

In other words, for example as illustrated in FIG. 9A, a loop antenna 21A having an external shape yielded by bending a long side of a rectangular shape of the coil 12 sharply at a right angle is formed. The loop antenna 21A is formed by the coil 12 being wound around the external shape yielded by bending a long side of the rectangular shape sharply at a right angle, and a magnetic sheet 20A having a shape conforming to this external shape is inserted into a central portion of the coil 12.

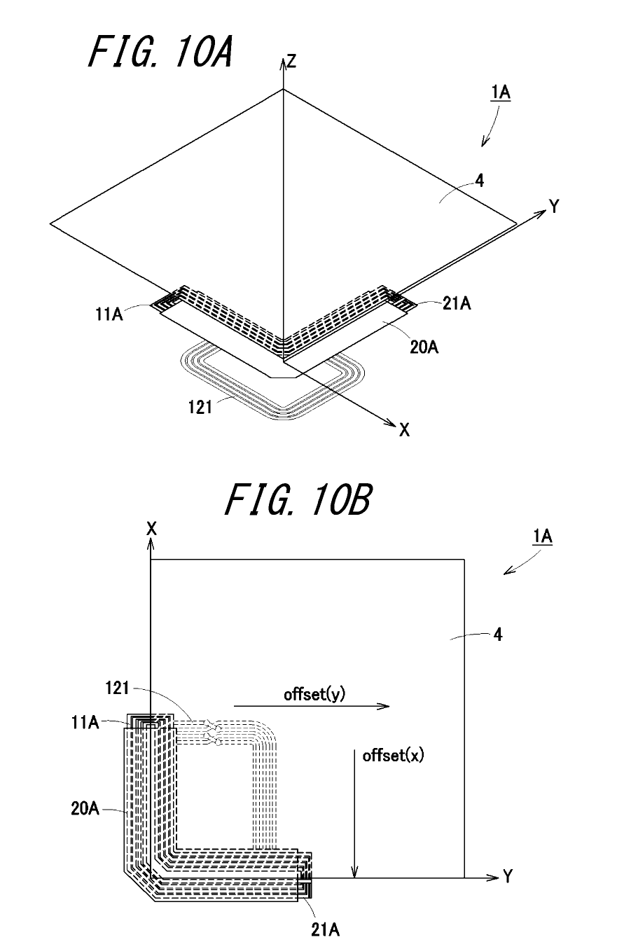

The antenna device 1 that includes the antenna coil 11 is, for example, disposed at an outer peripheral corner of the casing surface of an electronic apparatus as illustrated in FIG. 10A.

In FIG. 10A, the metal foil 4 is the second electric conductor in sheet form and is proximate to or in contact with the metal plate 3 that serves as the first electric conductor and that faces the external apparatus, i.e. the reader/writer 120. The metal foil 4 also at least partially overlaps a surface of the antenna coil 11, the surface being opposite to a surface facing the reader/writer 120.

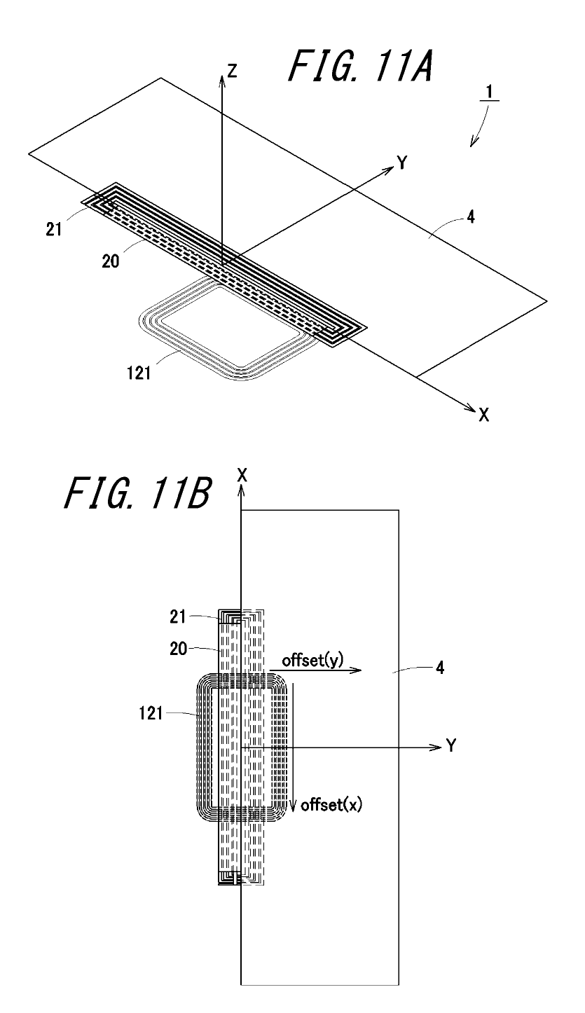

For example, in the loop antenna 21 having a basic structure in which the lead wire of the coil 12 is wound in a rectangular shape, as illustrated in FIG. 11A, there is a difference between the communicable region in the x-direction along the long side of the loop antenna 21 and the communicable region in the y-direction corresponding to the direction orthogonal to the long side of the antenna coil with respect to the antenna 121 (which is a loop antenna formed in an approximately rectangular shape) on the side of the reader/writer 120 that faces the loop antenna 21 in the xy-plane, as illustrated in FIG. 11B. The communicable region in the y-direction is narrower. Conversely, in the loop antenna 21A having an external shape yielded by bending a long side of the rectangular shape of the coil 12 sharply at a right angle, as illustrated in FIG. 10A, the communicable region in the y-direction of the loop antenna 21A is expanded with respect to the antenna 121 (which is a loop antenna formed in an approximately rectangular shape) on the side of the reader/writer 120 that faces the loop antenna 21A in the xy-plane, so that the communicable region in the x-direction and the y-direction can be made equivalent, as illustrated in FIG. 10B.

In the antenna coil 11A, the direction in which the long side of the rectangular shape of the coil 12 is bent points towards the inside of the metal foil 4, which is the second electric conductor.

The external shape of the loop antenna 21A may be formed by bending the long side of the rectangular shape of the coil 12 at a plurality of positions. For example, a loop antenna 21B having an external shape that is bent at two locations, such as an antenna coil 11B illustrated in FIG. 9B, may be formed. In the antenna coil 11B, the loop antenna 21A is formed by the coil 12 being wound around the external shape yielded by bending a long side of the rectangular shape at two locations, and a magnetic sheet 20B having a shape conforming to this external shape is inserted into a central portion of the coil 12.

The coil 12 may be bent in a curve instead of being bent sharply, and the loop antenna may have an external shape formed by bending a long side of the rectangular shape along the outer peripheral edge of the casing surface.

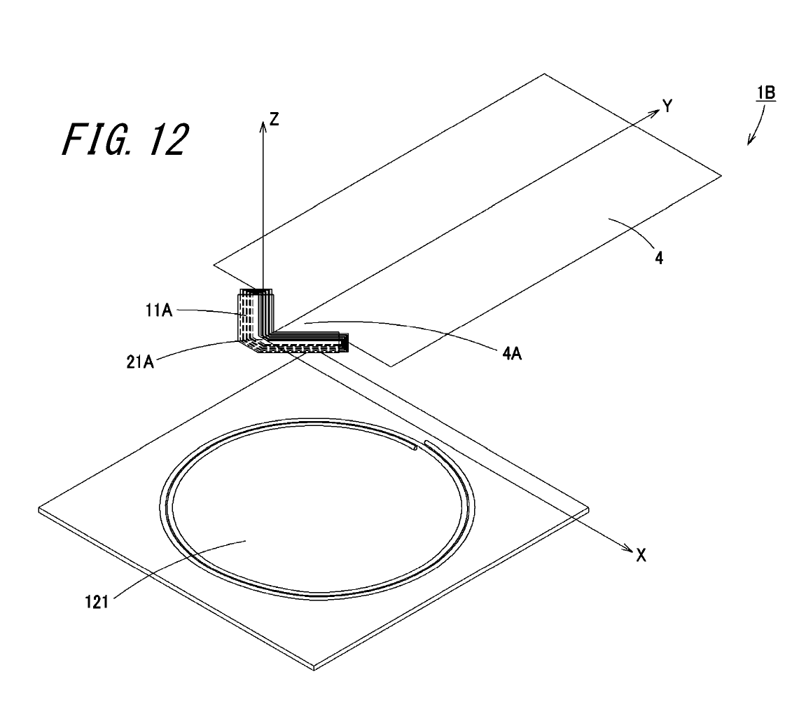

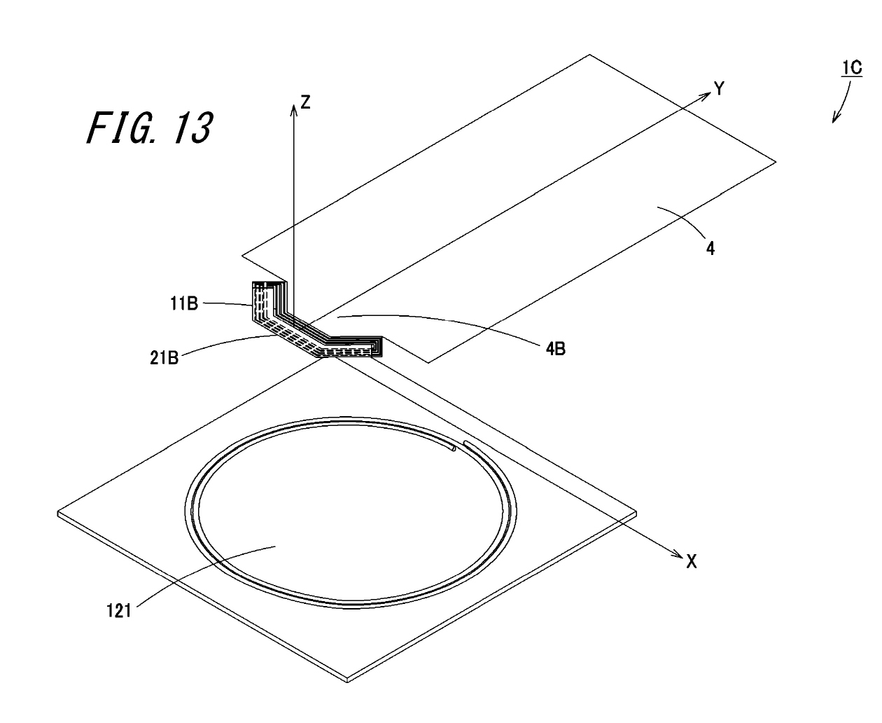

Furthermore, when mounting the antenna device 1 to which this disclosure is applied in the tip of an oblong electronic apparatus, such as a cellular phone, the antenna device 1 may be mounted in the central portion of the tip, as in the antenna devices 1B and 1C illustrated in FIGS. 12 and 13, instead of in the outer peripheral corner of the casing surface of the electronic apparatus. In this case, the metal foil 4 serves as the second electric conductor in sheet form, the metal foil 4 being proximate to or in contact with the metal plate 3 that serves as the first electric conductor and that faces the external apparatus, i.e. the reader/writer 120, and at least partially overlapping a surface of the antenna coils 11A and 11B, the surface being opposite to a surface facing the reader/writer 120. Furthermore, the metal foil 4 has projecting portions 4A and 4B, shaped to conform to the shape of the loop antennas 21A and 21B, and overlaps the loop antennas 21A and 21B.

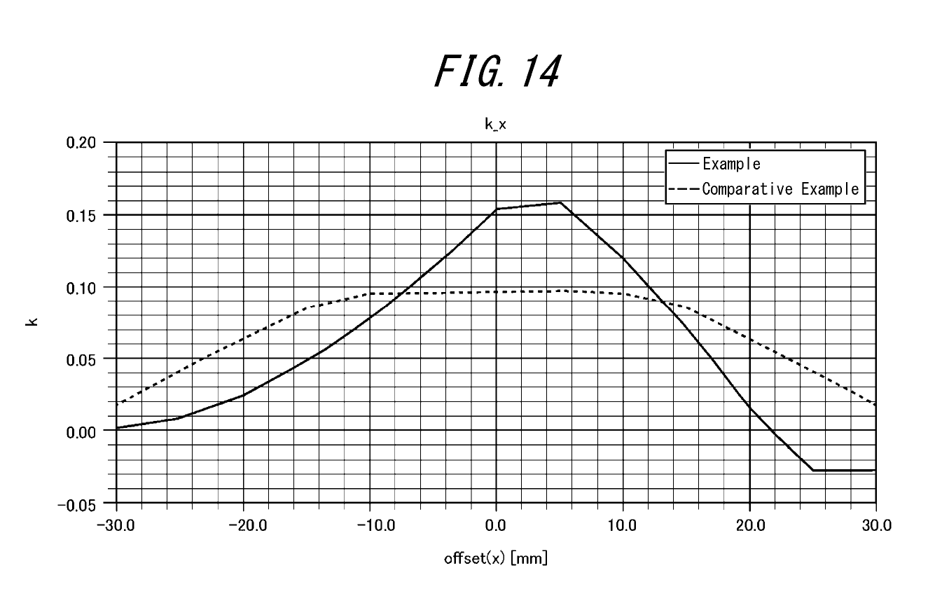

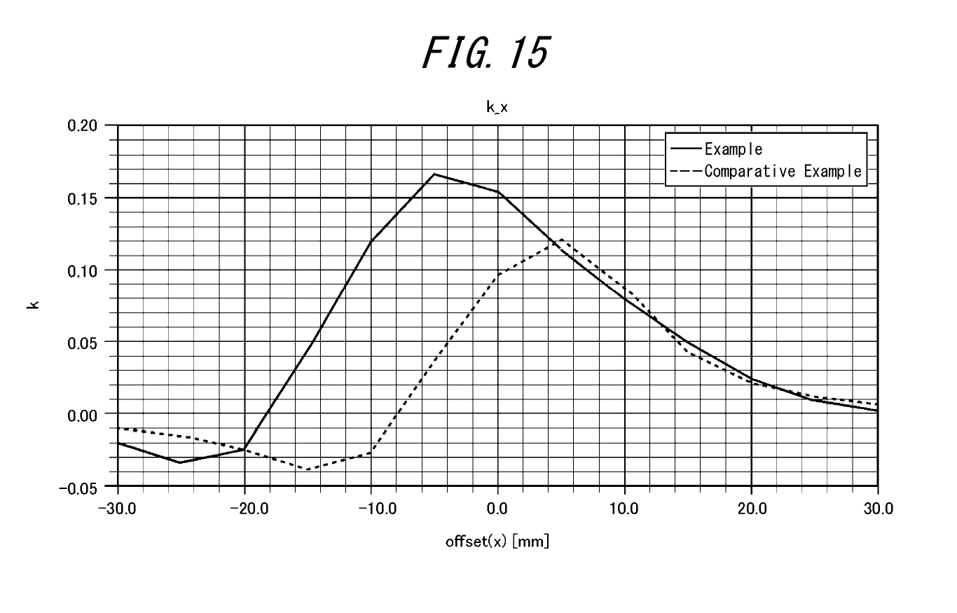

FIGS. 14 and 15 illustrate the results of simulations for an antenna device 1A according to an Example that includes the antenna coil 11A provided with the loop antenna 21 structured by bending a long side of the rectangular shape of the coil 12, as illustrated in FIGS. 10A and 10B, and an antenna device 1 according to a Comparative Example that includes the antenna coil 11 provided with the loop antenna 21 having the basic structure in which the lead wire of the coil 12 is wound in a rectangular shape, as illustrated in FIGS. 11A and 11B, the simulations showing the coupling coefficient when the antenna 121 of the reader/writer 120 is displaced.

FIG. 14 illustrates the coupling coefficient when the antenna 121 on the side of the reader/writer 120 that is facing in the xy-plane is displaced in the x-direction, and FIG. 15 illustrates the coupling coefficient when the antenna 121 is displaced in the y-direction. A coil with four turns and an external shape of 25 mm×20 mm was used as the antenna 121 of the reader/writer 120, and the distance from the antenna substrate of the antenna device was set to 5 mm.

The antenna device 1 according to the Comparative Example included a rectangular loop antenna 21 measuring 50 mm×8 mm, and stainless steel measuring 100 mm×50 mm×0.3 mm thick was used as the metal foil 4.

The antenna device 1A according to this disclosure included a loop antenna 21A having an external shape formed by bending a long side of a rectangular loop antenna measuring 50 mm×8 mm at a right angle, and stainless steel measuring 100 mm×50 mm×0.3 mm thick was used as the metal foil 4.

In the antenna device 1 according to the Comparative Example, for example the range over which a coupling coefficient of 0.05 was obtained was a range of approximately −23 mm to +23 mm for the offset (x), i.e. the displacement amount in the x-direction, and a range of approximately −4 mm to +14 mm for the offset (y), i.e. the displacement amount in the y-direction.

Hence, there was a difference between the communicable region in the x-direction along the long side of the loop antenna 21 and the communicable region in the y-direction corresponding to the direction orthogonal to the long side of the antenna coil, and the communicable region in the y-direction was narrower.

By contrast, in the antenna device 1A according to the Example, for example the range over which a coupling coefficient of 0.05 was obtained was a range of approximately −15 mm to +17 mm for the offset (x), i.e. the displacement amount in the x-direction, and a range of approximately −14 mm to +15 mm for the offset (y), i.e. the displacement amount in the y-direction. The communicable region in the x-direction was slightly narrowed, but the communicable region in the y-direction expanded, thereby improving the balance between the communicable regions in the x-direction and the y-direction with respect to the antenna 121 on the side of the reader/writer 120 that is facing in the xy-plane.

In other words, the antenna device 1A according to this disclosure is incorporated into an electronic apparatus and configured to communicate with an external device via an electromagnetic field signal, and the antenna device 1A includes a loop antenna 21A or 21B disposed on a peripheral portion of a casing surface of the electronic apparatus and having an external shape formed by bending a long side of a rectangular shape into which the coil 12 that inductively couples to the external device is wound, thereby improving the balance between the communicable regions in the x-direction and the y-direction with respect to the antenna 121 on the side of the reader/writer 120 that is facing in the xy-plane and allowing reliable communication via an electromagnetic field signal transmitted from the reader/writer 120.

### REFERENCE SIGNS LIST

1A, 1B, 1C Antenna device

2 Antenna module

3 Metal plate

4 Metal foil

11, 11A, 11B Antenna coil

12 Coil

13 Communication processor

14 Terminal

20 Magnetic sheet

21A, 21B Loop antenna

100 Wireless communication system

120 Reader/writer

121 Antenna

141 Outer casing

141a Inner circumference wall

142 Space

1. An antenna device incorporated into an electronic apparatus and configured to communicate with an external device via an electromagnetic field signal, the antenna device comprising:
a loop antenna disposed on a peripheral portion of a casing surface of the electronic apparatus and having an external shape formed by bending a long side of a rectangular shape into which an antenna coil that inductively couples to the external device is wound.

2. The antenna device of claim 1, wherein the external shape of the loop antenna is formed by bending the long side of the rectangular shape sharply.

3. The antenna device of claim 2, wherein the external shape of the loop antenna is formed by bending the long side of the rectangular shape at a plurality of positions.

4. The antenna device of claim 1, wherein the external shape of the loop antenna is formed by bending the long side of the rectangular shape along an outer peripheral edge of the casing surface.

5. The antenna device of claim 1, further comprising:
a first electric conductor provided inside a casing of the electronic apparatus and facing the external device; and
a second electric conductor in sheet form, provided inside the casing of the electronic apparatus, proximate to or in contact with the first electric conductor, and at least partially overlapping a surface of the antenna coil, the surface being opposite to a surface of the antenna coil facing the external device.

6. The antenna device of claim 5, further comprising:
a magnetic sheet configured to pull in a magnetic field transmitted from the external device in the antenna coil,
wherein the antenna coil and the magnetic sheet overlap each other by the magnetic sheet being inserted into a center portion of the antenna coil so as to satisfy a disposition condition such that, towards a center of a casing surface facing the external device, the magnetic sheet is positioned closer to the external device than the antenna coil is, and to satisfy another disposition condition such that, towards an outer periphery of the casing surface, the antenna coil is positioned closer to the external device than the magnetic sheet is.

7. An electronic apparatus incorporating an antenna device configured to communicate with an external device via an electromagnetic field signal,
wherein the antenna device comprises:
a loop antenna disposed on a peripheral portion of a casing surface of the electronic apparatus and having an external shape formed by bending a long side of a rectangular shape into which an antenna coil that inductively couples to the external device is wound;
a first electric conductor facing the external device;
a second electric conductor in sheet form, overlapping or in contact with the first electric conductor, and at least partially overlapping a surface of the antenna coil, the surface being opposite to a surface of the antenna coil facing the external device; and
a communication processor configured to communicate with the external device.
